(19) United States
(12) Patent Application Publication
(10) Pub. No.: US 2010/0105382 A1
(43) Pub. Date: Apr. 29, 2010

(54) ADDRESSING METHODS AND APPARATUS FOR USE IN A COMMUNICATION SYSTEM

(76) Inventor: Mark Gallagher, Berkshire (GB)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/603,390

(22) Filed: Oct. 21, 2009

Related U.S. Application Data
(60) Provisional application No. 61/107,283, filed on Oct. 21, 2008.

(51) Int. Cl. H04W 36/08; H04W 36/34

(52) U.S. Cl. 455/434; 455/436

(57) ABSTRACT

In a cellular communication network having a plurality of access points serving wireless terminals, methods and apparatus for facilitating handoff of a wireless terminal from a first access point to a second access point. In various embodiments, the process includes storing in a memory device at the wireless terminal a cell identifier, wherein the cell identifier includes a special character enabling the cell identifier to identify a plurality of access points to which the wireless terminal can be handed off; and the wireless terminal using the stored address information to determine access points to which a handoff may be implemented. One or more cell identifiers stored in the memory can be used as a neighbor list, which can be used to identify handoff possibilities or topographical adjacencies.

### CROSS-REFERENCE TO RELATED APPLICATIONS

This application claims priority from Provisional Application Ser. No. 61/107,283, which was filed on Oct. 21, 2008 and which is hereby incorporated herein by reference in its entirety.

### TECHNICAL FIELD

The present invention relates generally to wireless communications, and more particularly, some embodiments relate to methods and apparatus for femtocell addressing.

### DESCRIPTION OF THE RELATED ART

Perhaps the genesis of mobile telephones can be traced back to their predecessors: two-way radios that were regularly used in taxicabs, police cruisers, and other like vehicles. These early radios were of limited use and flexibility, and typically only provided half-duplex communications. More flexibility was introduced with the transportable telephones, also known as bag phones, which were used as mobile two-way radios, but could also be patched into the telephone network and used as portable phones.

The development of modern cellular technology is credited, in part to Bell Labs, whose engineers and scientists were responsible for such innovations as hexagonal cell transmissions for mobile phones and early developments in cellular telephony. However, Bell Labs was not alone. In 1973, Marty Cooper, the lead engineer of the team at Motorola that developed the handheld mobile phone, made what is believed to be the first public cellular telephone call. The call was placed to Dr. Joel S. Engel, head of research at AT&T's Bell Labs. This early work led to a paradigm shift from two-way radios and car phones to more personal, flexible and portable telephones, now known as mobile or cellular telephones.

Modern cellular communications utilize a series of base stations that relay communications from cellular telephones to other cellular phones and to the Public Switched Telephone Network (PSTN). The antenna towers for the base stations are geographically distributed in a manner so as to provide overlapping cell coverage to the subscriber mobile devices. As mobile devices move through coverage areas they are handed off from one base station to the next to provide mobile coverage.

A femtocell is a cellular base station that typically has a smaller cell coverage area than conventional macro cellular systems. Femtocells are typically intended for use in a home or small business and can be useful to extend the reach of cellular service to within a building, structure or other environment where cellular access would otherwise be limited or unavailable. Multiple femtocells can be controlled by a controller that connects to the service provider networks via a broadband communications link.

The femtocell generally mirrors the functionality of a conventional base station in a smaller form factor for indoor deployment. An example UMTS femtocell can contain a Node B, RNC and GPRS Support Node. However, femtocell applicability is not limited to UMTS, and they can be implemented with other standards, including for example GSM, CDMA2000, TD-SCDMA and WiMAX.

In many cellular systems, topology within a cellular network is managed by use of a “neighbor list,” which may be stored in a communications device. This neighbor list generally has finite size, typically 32 entries, and each neighbor is typically identified uniquely according to a CGI (cell global identifier) and/or the radio parameters that the base station is exhibiting (e.g. scrambling code, frequency, pilot signal identifier, special ID code etc), plus the triggers and levels and a hysteresis policy to execute a handover to manage mobility within the system. Accordingly, the neighbor list can be used in the handoff process to identify neighboring cells to which a handset might be handed off as it moves throughout the coverage area.

For macro cells with relatively large coverage area, the neighbor list is manageable, and 32 entries in conventional handsets is generally sufficient. However, as cell sizes shrink, such as in RAN or femtocell environments, and the number of possible neighbors grows, it becomes impractical to constantly churn the neighbor list even on a mobile-by-mobile basis to manage mobility. These methods in essence artificially create very long neighbor lists so that the small cell topologies can be managed, potentially on a radio-link by radio-link basis but at the risk of increased operational overhead.

According to standard practices, a cell global identifier (CGI) is commonly used for the nearest neighbor list. FIG. 1 is a diagram illustrating an example of a conventional CGI. The exemplary CGI 6 includes an MCC (mobile country code) field 8, a mobile network code (MNC) field 10, a location or routing identifier (LAI) field 11 and a cell identifier (CID) field 12. In the exemplary CGI 6, the LAI field 11 and the CID field 12 are both 16-bit addresses.

In methods described in the art and best current practice, the CID 12 is incremented by a unit every time a cell is added to the network, and the LAI is split into geographical paging areas so that nationwide contact is possible. When created, the CID 12 (at a 65,536 maximum possible addresses) was considered to be more than adequate for future needs as the largest cellular networks are ˜10,000 cells, and the LAI allowed the geographic area to be split up into postal code size regions. This methodology, however, is a very inefficient way of handling effectively a 2̂32 address space, and although having it human manageable is an advantage, it does not meet today's needs where base stations could number in the millions.

### BRIEF SUMMARY OF EMBODIMENTS OF THE INVENTION

Embodiments of the present invention are directed toward apparatus and methods for providing enhanced addressing of cells in a wireless communication system. In various embodiments, special characters such as wild cards and don't cares can be used in the addressing to enable identification of sets of locations with a single entry. Addressing techniques can allow hierarchical structures for topographical definition. Additionally, unique addressing can be used that shares the location and cell identifier fields in a standard cell structure to allow flexible allocation of address space among the two fields. A cell boundary or partition, or field length identifier can be determined based on anticipated allocation needs as among locations and cells within those locations. The location and cell identifiers can be assigned from opposite ends of the shared cell, allowing flexibility for growth between the two fields.

In some embodiments, a method is provided in a cellular communication network having a plurality of access points serving wireless terminals for facilitating handoff of a wireless terminal from a first access point to a second access point, including the operations of: storing in a memory device at the wireless terminal a cell identifier, wherein the cell identifier includes a special character enabling the cell identifier to identify a plurality of access points to which the wireless terminal can be handed off; and the wireless terminal using the stored cell identifier to determine access points to which a handoff may be implemented. The cell identifier can include a cell identification field configured to store a first data representation identifying a cell in the cellular network; a location identification field adjacent the cell identification field and configured to store a second data representation identifying a location in the cellular network; and wherein one of the first and second data representations can be constructed from a least significant bit of its respective field and the other of the first and second data representations is constructed from the most significant bit of its respective field.

In some implementations, the cell identification field and the location identifier field are a contiguous concatenated field and further comprising a partition in the concatenated field between the cell identification field and the location identifier field defining a bound to the number of bits in each field. The special character can include a wild card or a don't care character.

The cell identifier stored in the memory device at the wireless terminal can be used as an access point neighbor list, which can identify access point topological adjacencies in the communication network, or can identify access points to which a handoff may be implemented. The list can include one or more cell identifiers stored in the memory device, and a subset of some or all of the cell identifiers in the access point neighbor list can include one or more special characters. In one embodiment, the cell identifiers are assigned to access points in logical groupings based on handoff probabilities.

In one embodiment, a wireless terminal for use in a cellular communication network having a plurality of access points serving wireless terminals includes a wireless transceiver configured to send communications to and receive communications from an access point; a memory storing a cell identifier that includes a special character enabling the cell identifier to identify a plurality of access points to which the wireless terminal can be handed off; and a control module configured to use the stored cell identifier to determine access points to which a handoff may be implemented.

The cell identifier can include a cell identification field configured to store a first data representation identifying a cell in the cellular network; a location identification field adjacent the cell identification field and configured to store a second data representation identifying a location in the cellular network; and wherein one of the first and second data representations can be constructed from a least significant bit of its respective field and the other of the first and second data representations is constructed from the most significant bit of its respective field.

In some implementations, the cell identification field and the location identifier field are a contiguous concatenated field and further comprising a partition in the concatenated field between the cell identification field and the location identifier field defining a bound to the number of bits in each field. The special character can include a wild card or a don't care character.

The cell identifier stored in the memory device at the wireless terminal can be used as an access point neighbor list, which can identify access point topological adjacencies in the communication network, or can identify access points to which a handoff may be implemented. The list can include one or more cell identifiers stored in the memory device, and a subset of some or all of the cell identifiers in the access point neighbor list can include one or more special characters. In one embodiment, the cell identifiers are assigned to access points in logical groupings based on handoff probabilities.

In yet other embodiments, an access point for use in a cellular communication network having a plurality of access points serving wireless terminals includes a wireless transceiver configured to send communications to and receive communications from a wireless terminal, wherein communications sent to the wireless terminal include a cell identifier that includes a special character enabling the cell identifier to identify a plurality of access points to which the wireless terminal can be handed off such that the wireless transceiver can use the stored address information to determine access points to which a handoff may be performed.

The cell identifier can include a cell identification field configured to store a first data representation identifying a cell in the cellular network; a location identification field adjacent the cell identification field and configured to store a second data representation identifying a location in the cellular network; and wherein one of the first and second data representations can be constructed from a least significant bit of its respective field and the other of the first and second data representations is constructed from the most significant bit of its respective field.

In some implementations, the cell identification field and the location identifier field are a contiguous concatenated field and further comprising a partition in the concatenated field between the cell identification field and the location identifier field defining a bound to the number of bits in each field. The special character can include a wild card or a don't care character.

The cell identifier stored in the memory device at the wireless terminal can be used as an access point neighbor list, which can identify access point topological adjacencies in the communication network, or can identify access points to which a handoff may be implemented. The list can include one or more cell identifiers stored in the memory device, and a subset of some or all of the cell identifiers in the access point neighbor list can include one or more special characters. In one embodiment, the cell identifiers are assigned to access points in logical groupings based on handoff probabilities.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating an example of a conventional cell global identifier.

FIG. 2 is a diagram illustrating a simplified architecture for an example environment of the invention.

FIG. 3 is a diagram illustrating an example communication system in accordance with one embodiment of the invention.

FIG. 4 is a diagram illustrating an example of a concatenated cell identifier in accordance with one embodiment of the invention.

FIG. 5 is a diagram illustrating an example implementation of the cell identifier illustrated in FIG. 4 in accordance with one embodiment of the invention.

FIGS. 6 and 7 are a diagram illustrating an example process for creating a concatenated cell identifier in accordance with one embodiment of the invention.

FIG. 8 is a diagram illustrating an example process for assigning a location identifier in accordance with one embodiment of the invention.

FIG. 9 is a diagram illustrating an example process for assigning a cell identifier in accordance with one embodiment of the invention.

FIG. 10 is a diagram illustrating an example embodiment for assigning a network code in accordance with one embodiment of the invention.

FIG. 11 is a diagram illustrating an example of a concatenated cell identifier in accordance with one embodiment of the invention.

FIG. 12 is a diagram illustrating examples for setting a boundary between a location identifier and a cell identifier in accordance with example implementations of the invention.

FIG. 13 is a diagram illustrating another example for the concatenated cell identifier in accordance with additional implementations of the invention.

FIG. 14 is a diagram illustrating a block diagram for an example wireless access point or base station in accordance with one embodiment of the invention.

FIG. 15 is a diagram illustrating an example architecture for a wireless handset in accordance with one embodiment of the invention.

FIG. 16 is a diagram illustrating an example computing module in accordance with one embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Embodiments of the systems and methods described herein are directed toward providing the ability for a network operator to create a scalable topology that allows extension of cell addressing that is compatible with existing processes and network elements. Further embodiments, allow the introduction of wildcards, don't cares and overloaded address states for addressing such that the operational goals can be met but without the operational burden. This can be implemented so as to effectively shrink the neighbor list and allow a finite number of identifiers to be applied to a larger set of addressable devices. Implementations that are scalable can be provided to allow greater numbers (e.g., thousands) of neighbors to be added to existing macro cells using relatively few entries.

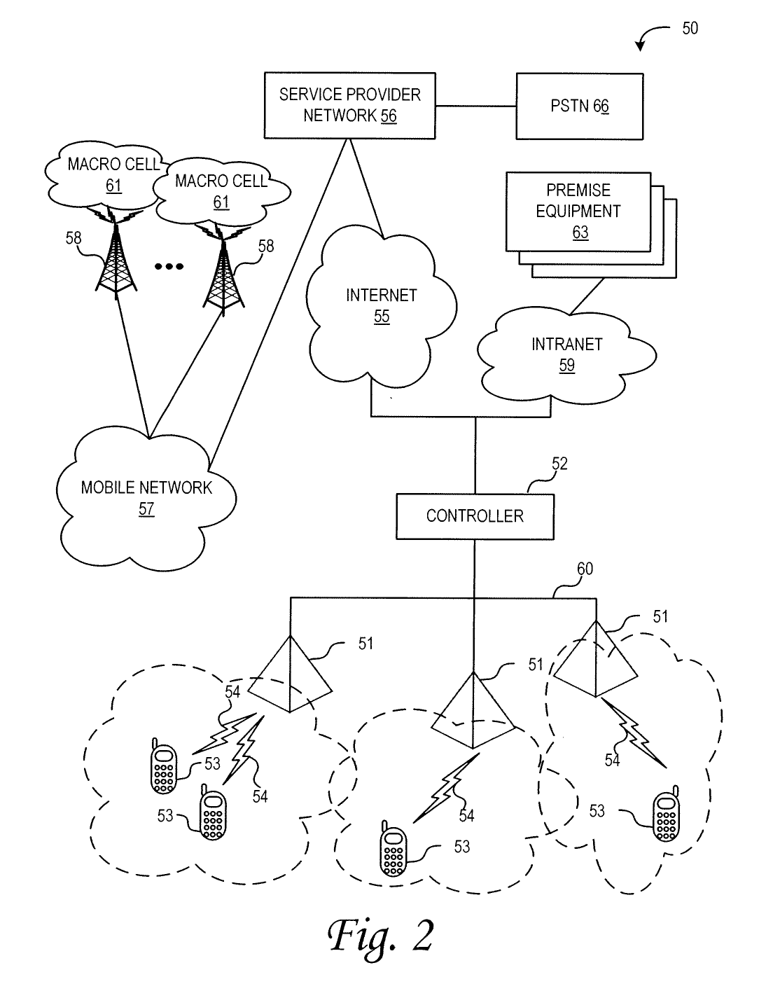

Before describing the invention in detail, it is useful to describe an example environment in which the invention can be implemented. One such example is that of a centrally-controlled femtocell system. FIG. 2 is a diagram illustrating a simplified architecture for such an example environment. In this example environment, one or more femtocells provide cellular coverage for wireless terminals. In some embodiments, wireless terminals can include handsets or other user equipment such as, for example cellular phones, smart phones, laptops, handheld communication devices, handheld computing devices, satellite radios, global positioning systems, PDAs, and/or any other suitable device for communicating over the wireless communication system.

In the illustrated example, femtocells 51 serve as base stations to provide cellular coverage over an air interface 54 to user equipment 53 within their respective areas of coverage. For example, femtocells 51 may be deployed at various locations within a building or other structure to provide cellular coverage to user equipment 53 within the building or structure. This can be advantageous, for example, in large buildings, underground facilities, within aircraft or other transportation vehicles, and within other structures and locations where conventional macro cell coverage is weak or insufficient. Femtocells can also be deployed in environments where it is desirable to augment the capacity of the conventional macrocellular network. Consider the case of a building with a plurality of femtocells distributed therein. In such an environment, the user equipment 53 registers with a femtocell 51 in its range within the building. As the user moves throughout the building, her cellular handset (or other terminal) may be handed off from one femtocell 51 to another to provide suitable coverage for her user equipment 53 as she moves within the building.

In various embodiments, user equipment 53 may comprise, for example, a cellular or mobile handset, a PDA having cellular system access, a laptop with cellular system access for data transmission over cellular systems, or other devices capable of accessing licensed spectrum communications networks for voice or data transmissions. In such applications, femtocells 51 are wireless access points configured to operate within the licensed spectrum to serve as base stations for the user equipment within their range. In other embodiments, femtocells 51 can be implemented as wireless access points for communications with compatible wireless terminals over proprietary or other non-licensed air interface. Although femtocells 51 are illustrated as exclusively wireless access points, embodiments can be implemented wherein femtocells 51 are implemented with wired interfaces to user equipment or a combination of wired and wireless interfaces.

As noted above, femtocell 51 operates as a base station and relays voice and data communication between the user equipment 53 and an end destination. For example, the end destination can be other user equipment within the building (for example, other wireless terminals 53, or other premise equipment 63), a cellular handset operating on a macro cell 61, the PSTN 66, Internet 55 accessible devices and so on.

In the illustrated environment, the femtocells 51 are centrally controlled by a controller 52, sometimes referred to as an access controller. Controller 52 may perform various functions, such as, for example, monitoring operations, coordinating communications among user equipment 53, relaying communications between user equipment 53 and other entities, licensed spectrum allocation, or load balancing amongst the femtocells 51. Femtocells 51 can be connected to access controller 52 via a backhaul 60 which can be implemented using a number of different communication topologies. The connections between the femtocells 51 and the access controller 52 could be dedicated, or the access points and controller could be coupled to one another via a switching network, such as a gigabit Ethernet network, for example.

Femtocells 51 are configured to provide cellular system access by transmitting voice and data transmissions to controller 52, which routes the communications via a packet switched network, such as the Internet 55, via an Intranet 59 or other communication path as appropriate. Accordingly, in some environments controller 52 may comprise a router or switch configured to allow the femtocells 51 to share a network connection and to access networks 55, 59. Controller 52 may also be configured to make routing determinations from among the various entities such that communications with a given wireless terminal 53 may be routed to at least one of the mobile network 57, other femtocells 51 other premise equipment 63 attached to the intranet 59, or other entities as may be accessible by controller 52.

In some examples, the system may further comprise a local intranet 56. For example, the controller 52 and femtocells 51 may be maintained by or integrated with an entity, such as a business or organization that also maintains its own local intranet 56. In some cases, users of the user equipment 53 may desire access to the intranet 56, such as for local data transfers or local voice calls. In such environments, the controller 52 may also mediate these communication activities.

The example environment further comprises a service provider network system 56. For example, the service provider network system may comprise a 2G or 2.5G network such as GSM, EDGE, IS-95, PDC, iDEN, IS-136, 3G based network such as GSM EDGE, UMTS, CDMA2000, DECT, or WiMAX, or any other cellular or telecommunications or other network. Service provider network system 56 further comprises a cellular network 57, that can include mobile switching centers, base station controller and base stations 58 configured to provide macro cell coverage 61 in the environment.

Sometimes, the coverage area of macrocell 61 may overlap with that of femtocells 51, in such cases the controller 52 or the femtocells 51 may provide methods for mitigating interference between the elements. In some instances, user equipment 53 may move from areas covered by femtocells 51 to areas covered by macrocell 61. In these cases, the controller 52 may provide methods for handing off calls from the femtocells 51 to the macrocell 61. In other cases, the network system 56 or other network elements may mediate these transitions.

From time to time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

For example, the innovations described herein often refer to access points and access controllers. As would be apparent to one of ordinary skill in the art after reading this description depending on the nature of the innovation, various embodiments may implement these components as components of a femtocell network (such as the example described with reference to FIG. 2, or as other access point and controller elements (e.g., base stations and base station controllers) in macro cells, other radio access networks, or other like topologies. Additionally, in peer-to-peer environments, coordination and control mechanisms can be assigned to and distributed amongst the various peer elements, or certain peers may be designated as super peers with additional control mechanisms over the other peers. Super peers can be identified, for example, when the network configuration is mapped and network neighbors identified. Accordingly, access point and access controller functions can, in some embodiments, be distributed amongst peers, delegated to super peers, or shared amongst peers and super peers.

For instance, in standards-based 3GPP HSPA systems (UMTS Release 6), the infrastructure element access point or base station is referred to as a “NodeB,” which can be referred to as Home NodeB, or HNB, for femtocell applications, which is known to those of one of ordinary skill in the art familiar with 3GPP systems. The serving NodeB is responsible for allocating a maximum transmit power resource to a wireless terminal (referred to as user equipment, user element or UE in UMTS specifications). In 3GPP LTE (Long Term Evolution) and like systems, uplink power control utilizes a closed-loop scheme around an open-loop point of operation. In 802.16 WiMAX systems, the serving base station is responsible for allocating an OFDMA resource element as well as potentially a maximum transmit power resource to the wireless terminal (called Subscriber Station or SS in the WiMAX specifications). Although many of the examples provided herein are described in terms of a UMTS application, after reading this description one of ordinary skill in the art will understand how these techniques can be implemented in alternative environments.

Although the environments described above can be characterized as a femtocell, macro cellular network or other like topological structure, the methods and apparatus described herein are also well suited to other scenarios, environments and applications, such as a wireless network or a system deployment that has no access controller but comprises distributed wireless access points, which can communicate in a peer-to-peer manner. The innovations described herein are not constrained by the actual choice of wireless protocol technology or network topology, but may be implemented across a wide range of applications as will be appreciated by one of ordinary skill in the art after reading this description.

The innovations described herein are applicable to licensed-spectrum-based cellular technologies in which infrastructure elements such as base stations or access points are provided as entities in the system with some level of coordination. In addition, the innovations are also applicable to unlicensed-spectrum with or without coordinating entities, including, for example, technologies such as WiFi and other technologies that employ peer-to-peer communication techniques.

In hierarchical systems, various functions described herein can be centralized in a control node such as a base station controller or access controller; distributed among like nodes such as base stations or access points; or distributed throughout the hierarchy in base stations and base station controllers. Also, the functions can be included in wireless terminals as well. However, a preferred embodiment relies on base stations or base station controllers to exchange information and instructions and can use wireless terminals in the manner designed for existing networks so as to avoid the need to update or modify existing wireless terminals or run a thin client on the terminals. For example, as certain of the below-described embodiments illustrate, the access points can be configured to instruct the wireless terminals to transmit known signals (such as pilot signals, for example); and can use existing control mechanism such as uplink power control. The systems can also be configured to take measurements of wireless terminal operations to make decisions to avoid, reduce or minimize interference. Other embodiments may place some of these control mechanisms on the wireless terminals or make other distribution of functionality than those examples described herein.

In peer-to-peer environments, coordination and control mechanisms can be assigned to and distributed amongst the various peer elements, or certain peers may be designated as super peers with additional control mechanisms over the other peers. Super peers can be identified, for example, when the network configuration is mapped and network neighbors identified.

Various innovations are described in this document in the context of an exemplary embodiment of the system, such as the example environment described above with reference to FIG. 2, which comprises multiple wireless access points, coupled to an access controller. The connections between the access points and the controller could be dedicated, or the access points and the controller could be coupled to one another via a switching network, such as a gigabit Ethernet network, for example. It should be noted that the innovations are also applicable to wireless system architectures that differ from the example environment and exemplary embodiments described herein, such as a completely distributed system that involves access points that can communicate between themselves in a peer-to-peer manner.

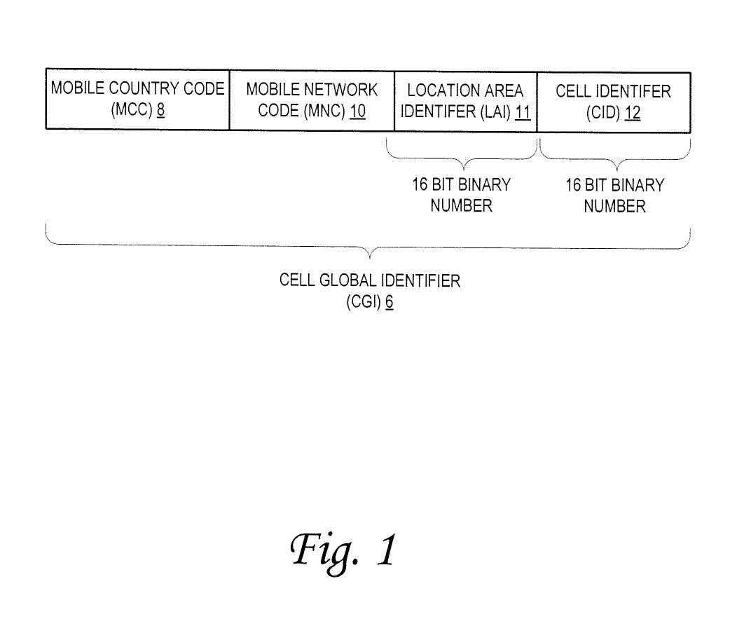

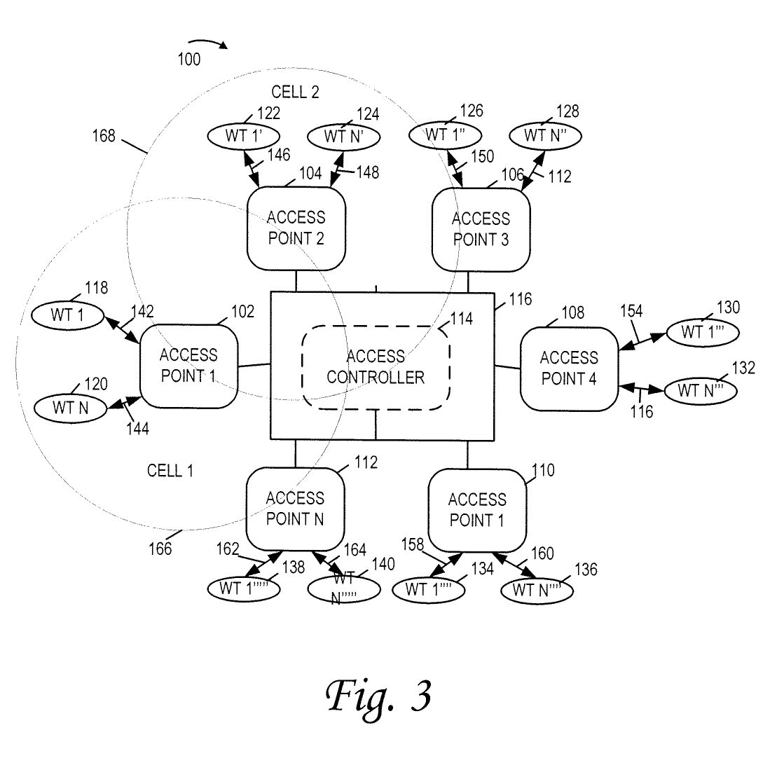

FIG. 3 is a diagram illustrating an example communication system in accordance with one embodiment of the invention. The example illustrated in FIG. 1 depicts a cellular type of architecture, such as a femtocell or other cellular architecture, that includes a single access controller 114 that can be used to control and communicate with a plurality of access points 102, 104, 106, 108, 110 and 112. In this example, the access points 102, 104, 106, 108, 110, 112 are all wireless access points that communicate with a plurality of wireless terminals such as handsets, for example, or other wireless devices. Accordingly, the access points can each define a communication cell, an example of which can include a femtocell. To avoid excessive clutter in the drawings, only two cells 166, 168 are illustrated. Cell 1 166 illustrates an example coverage area for access point 102 and cell 2 168 illustrates an example coverage area for access point 104. As will be appreciated by one of ordinary skill in the art after reading this description, the other access points will also have corresponding areas of cell coverage.

The access points 102, 104, 106, 108, 110, 112 are communicatively coupled to access controller 114 by way of a backhaul 116. For example, in various embodiments, backhaul 116 can be implemented utilizing a communication network such as a packet-switched network. Likewise, alternative communication schemes or topologies can be implemented for backhaul 116. In some embodiments, access controller 114 is configured to coordinate or control at least some of the operations of at least some of the access points 102, 104, 106, 108, 110, 112. Likewise, access controller 114 can serve as a base station to relay communications among the access points 102, 104, 106, 108, 110, 112 (and ultimately their respective wireless terminals), as well as between the access points 102, 104, 106, 108, 110, 112 and their respective wireless terminals and other entities.

The access points 102, 104, 106, 108, 110, 112 are configured to communicate with wireless devices 118 . . . 140 within their respective cells. Such communications can comprise voice and data communications. Examples of wireless devices can include a cellular phone or other wireless terminal. Accordingly, at least some of the wireless terminals can be mobile devices that may move into and out of communication system 100 as well as within communication system 100. In FIG. 1, wireless terminals 118 . . . 120 are coupled to access point 102 via wireless links 142 . . . 144. Likewise, wireless terminals 122 . . . 124 are coupled to access point 104 via wireless links 146 . . . 148, and so on for the other access points 106, 108, 110, 112 as depicted in this example. In some embodiments, the geographical locations of the access points are known to the controller as well as to the access points.

FIG. 3 generally depicts a cellular architecture in which a plurality of cells or access points are distributed to provide coverage cells to the multiple wireless terminals in the coverage areas. The access points are under control and coordination of the access controller. Accordingly, FIG. 1 can represent a number of different communication architectures such as a femtocell architecture and a macro cell architecture. The various embodiments discussed below are described in terms of the components and topology illustrated in FIG. 1. However, after reading these descriptions, it will be apparent to one of ordinary skill in the art how these embodiments can be implemented with other architectures.

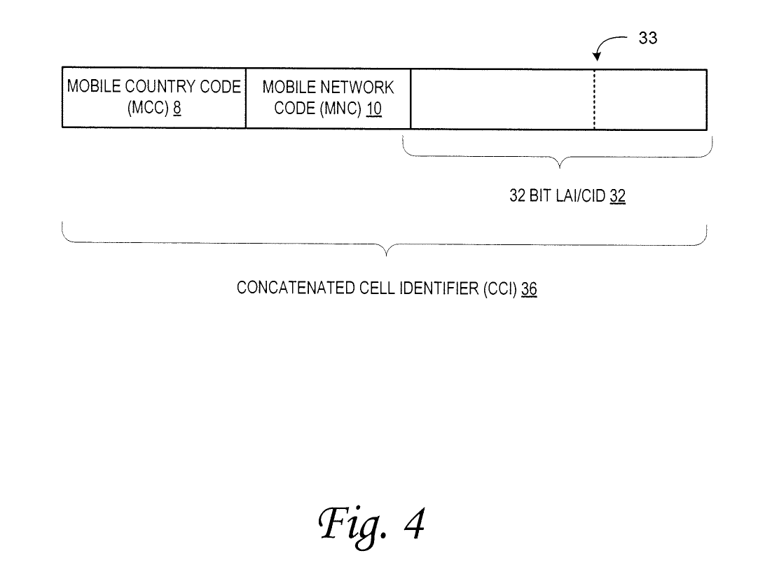

FIG. 4 is a diagram illustrating an example of a concatenated cell identifier in accordance with one embodiment of the invention. Referring now to FIG. 4, in this example the concatenated cell identifier 36 includes a mobile country code field 8, a mobile network code 10, and a combined location and cell identifier field 32. In this example embodiment, mobile country code 8 and mobile network code 10 can be implemented as in the conventional cell global identifier 6, although other country and network codes are possible. In this example, the location and cell identifier field 32 is a 32-bit field that has a flexible boundary 33 between the location or routing identifier (such as an LAI) any cell identifier (such as a CID). Although other bit lengths are possible for this field, maintaining a 32-bit length allows the concatenated cell identifier 36 to maintain compatibility with conventional cell identifiers such as the cell global identifier six.

As indicated by dashed line 33, the allocation of the bit space (in this example 32 bits) as between the location or routing identifier and the cell identifier can be adjusted based on network topology or configuration or based on other factors. Accordingly, the flexibility to partition this address space allows scalability of the cell identifier or the location or routing identifier. For example, consider an example in which partitioning 33 is established such that the top eight bits are designated for the location area identifier and the remaining 24 bits are reserved for the cell identifier. In such an example, there could be up to 256 location areas designated, but there could be 2̂24 cell identifiers, or more than 16,000,000 base stations in each of the 256 identified locations. As another example, if the location area is designated as 20 bits in length, there can be 4096 base stations described. In various embodiments, the partitioning efficiency or decisions on partitioning can be delegated to the network operator to make a partitioning decision based on network configuration or other factors.

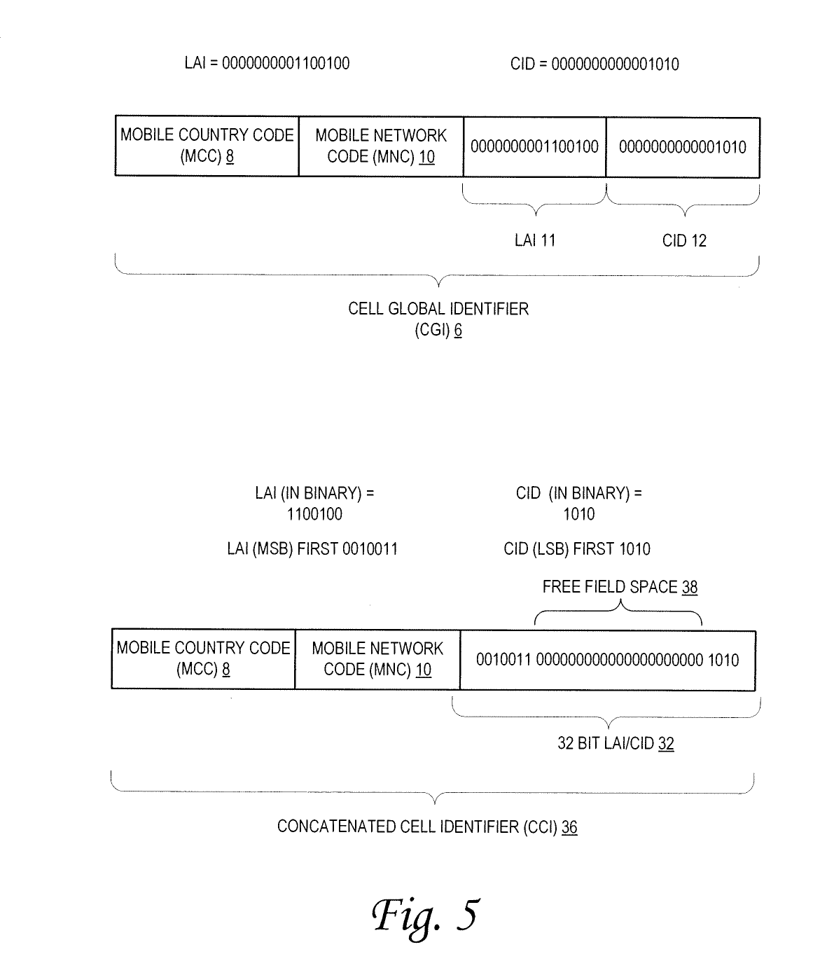

FIG. 5 is a diagram illustrating an example implementation of the cell identifier 36 illustrated in FIG. 4 in accordance with one embodiment of the invention. In this example, a specific location identifier, 110010, and cell identifier 1010 are illustrated as making up the 32 bit LAI/CID 32. In this example embodiment, the location identifier is shifted to the most significant bits of the 32-bit location and cell identifier 32, and the cell identifier is shifted to the least significant bits of the 32-bit location and cell identifier 32. Further in this example, the bit order of the location identifier is reversed such that the most significant bit is in the least significant bit position. Accordingly, the location identifier is shown as 010011. As this example illustrates, there is a free field space 38 that has been freed up in this example that can be used to allow flexible positioning of the partition between the location identifier field and the cell identifier field. Examples of how these fields can be created and implemented are described in further detail below.

In the example illustrated in FIG. 5, the mobile country code field 8 and a mobile network code 10 are unchanged from conventional fields. As this example illustrates the location identifier can be left justified and binary identifiers used.

As an example the LAI is can be left justified and binary identifiers used. For example, the location identifier can be created as
1st entry 1
2nd entry 01
3rd entry 11
4th entry 001
and so on
The cell identifier can be right justified and uniquely associated with each local identifier. For example
1st entry 1
2nd entry 10
3rd entry 11
4th entry 100
and so on

Accordingly, the location identifier and cell identifier combinations or possibilities in this flexibly defined address space can be greater than geographically-based constraints or incrementing a counter of equipment in the network.

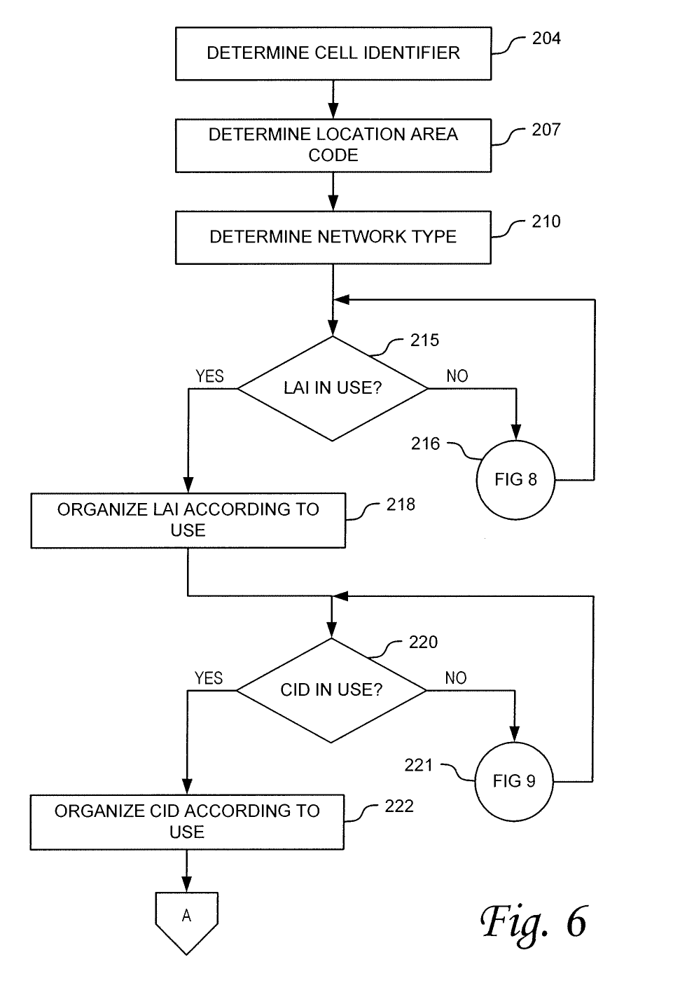

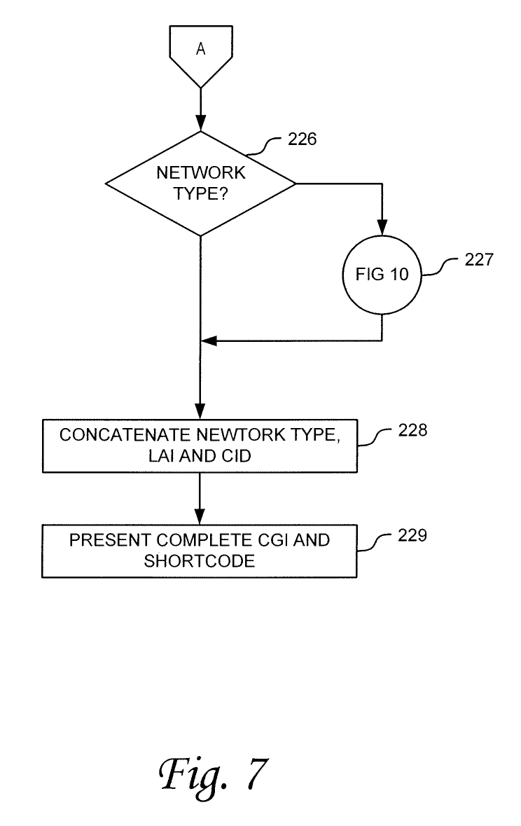

FIGS. 6 and 7 are a diagram illustrating an example process for creating a concatenated cell identifier 36 in accordance with one embodiment of the invention. Referring now to FIG. 6, in a step 204 a cell identifier is determined. Cell identifiers can be defined by, for example, a network operator and organizing the network and adding new cells to the network. In a step 207 the location area code is defined. Again, this can be determined by the network operator in architecting the network. Similarly, in step 210, a network type can be determined.

With the location area determined or defined, in a step 215 the process can determine whether that location identifier exists and is in use. If so, in step 218 the location identifier is organized and implemented according to its current use. If not, a new location identifier can be defined at step 216. That is, a location identifier may already be defined for the combined location/cell identifier 32 and used, or a new one created. A similar process can be implemented for the call identifier as illustrated by steps 220, 221 and 222, in which it is determined whether the designated call identifier is in use and if so, implementing the call identifier according to its current use or defining a new call identifier.

The process continues in FIG. 7 for creation of the combined location and cell identifier. In the process illustrated in FIG. 7, it is determined whether a network type is required as illustrated by step 226. If so, the network type is created at step 227. The use of network types can be included to allow network type designations to be incorporated within the location and cell identifier field 32. If the network type is used, it can be concatenated with the location and cell identifiers as illustrated at step 228. Otherwise, the network type is not included. Finally, in step 229, the concatenated or combined cell and location identifier (with or without the network type) can be concatenated with the mobile country code 8 and mobile network code 10 to create the concatenated cell identifier 36.

In the example described above, the location of the flexible partition 33 can be selected at the outset, before a location or cell identifier is identified such that the network operator or other configuration entity can determine an appropriate balance for the growth of the location and cell identifiers. Additionally, in various embodiments, the placement of the flexible partition 33 can be allowed to change over time as the network buildout continues to occur or as the network evolves. This can allow flexibility in arranging and organizing the network topology to allow flexible growth and evolution. As described below, various embodiments can allow a hierarchical structure for location and cell identification to allow greater flexibility in field assignments and network growth. Furthermore, although the examples depicted above illustrate the determination of the cell and location identifier before it is determined whether each one is in use, the respective steps can also be performed sequentially.

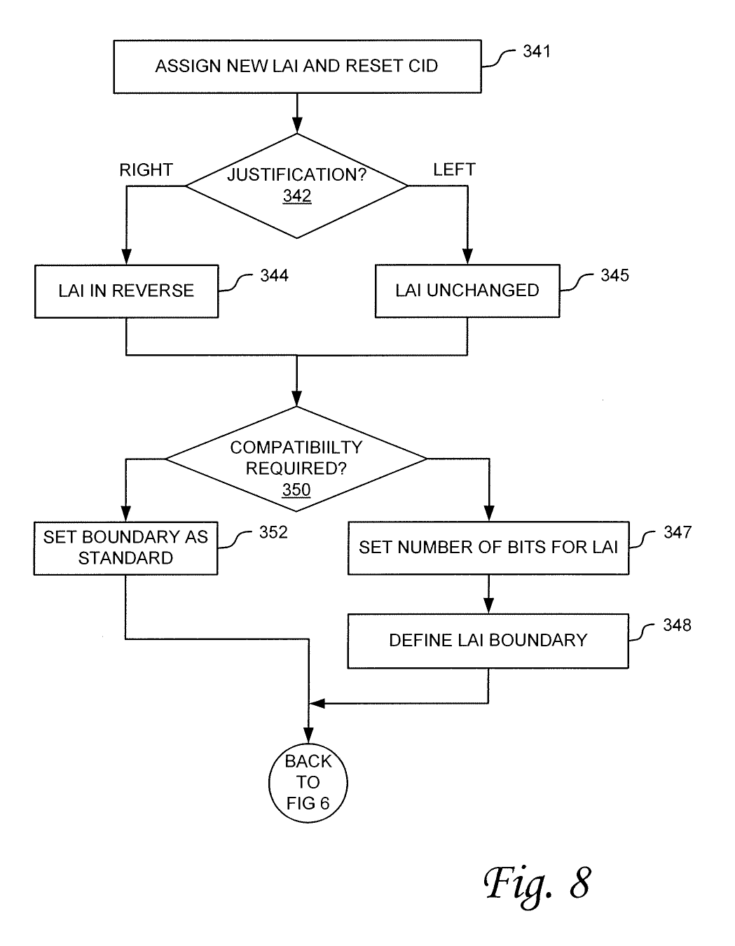

FIG. 8 is a diagram illustrating an example process for assigning a location identifier in accordance with one embodiment of the invention. For example, FIG. 8 illustrates a sample process for performing step 216 of FIG. 6 in accordance with one embodiment. Referring now to FIG. 8, at step 341 a new location identifier can be assigned. Additionally, in this step, the cell identifier can be reset, for example, to zero. This can allow a unique set of cell identifiers to be used for the new location identifier. The location identifier can be determined by the network operator or other entity as an identifier for a new location being provisioned. For example, location identifiers can be assigned sequentially, or they can be assigned in a way that allows sorting or grouping to take advantage of wild card and don't care states as further described herein.

In step 342, the cell justification is determined. If it is determined for example that right justification is used as illustrated in the example of FIG. 5, the new location identifier is assembled in reverse (step 344) and the operation continues. Otherwise, if left justification is used, the location identifier is left unchanged as illustrated by step 345. In step 347, the number of bits can be established for the location identifier. That is, a network operator or other configuration entity can determine the number of locations that might be defined in a given network and can then set the number of bits required to allow a sufficient number of unique location identifiers accordingly. In one embodiment, this is done in advance of establishing the cell identifiers for the network and may remain unchanged throughout the operation of the network. In other embodiments, the determination of the number of bits can be flexible and be allowed to change over time as the network topology or topography changes with a growing or evolving network. With the number of bits determined, in a step 348 the partition is defined. For example, this can be flexible partition 33 as illustrated in FIG. 4. However, in some applications, compatibility with conventional networks will be required if so, the boundary can be set according to these defined standards to allow such compatibility. Otherwise the boundary can be set as determined. With the location identifier determined the operation continues at FIG. 6.

In the illustrated example, determining whether compatibility is required is illustrated as occurring after the number of bits required for the location identifiers has been established. However, in other embodiments, the determination of compatibility can be decided in advance the step of determining the number of bits to be allocated for the location identifier. As such, in situations where a fixed boundary is required (as per standards, for example) or if the boundary has already been defined, the steps of defining a flexible boundary can be bypassed.

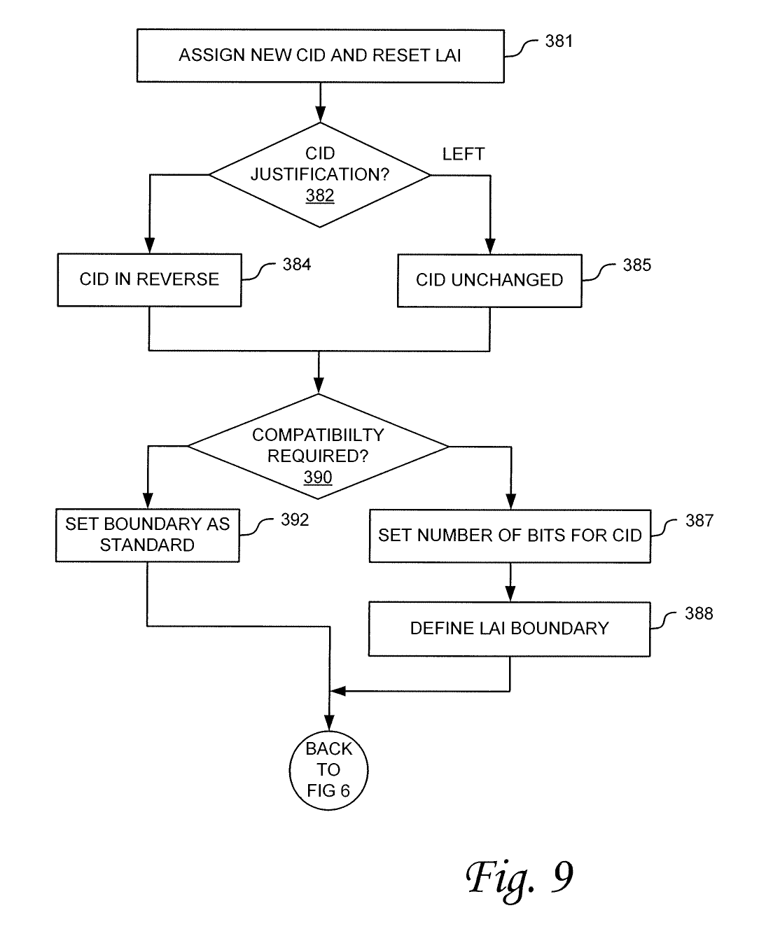

FIG. 9 is a diagram illustrating an example process for assigning a cell identifier in accordance with one embodiment of the invention. In this particular example, FIG. 9 is a sample process for performing step 221 in FIG. 6 in accordance with one embodiment. Referring now to FIG. 9, in a step 381 a new cell identifier is defined by the network operator or the configuration entity. In conjunction with this step, the location identifier can be reset, or, in some embodiments, the cell identifier is assigned based on an available cell identifier for a given location identifier. Accordingly, for example, the cell identifier assigned might be the next sequential cell assignment number for the given location. As further described below, in other embodiments, cell identifiers may be defined and chosen based on a logical layout or hierarchical structure to allow the system to take advantage of wildcards, don't care states, or other logical or hierarchical knowledge to allow further efficiencies in the system. As with the process for determining a new location identifier, the process for assigning a new call identifier can also check the desired justification and reverse the bits (or not) depending on the justification desired. This is illustrated in steps 382, 384 and 385. In tams of the example illustrated in FIG. 5, the justification for the cell identifier is not changed.

If compatibility for the cell identifier 36 is required with standard networks, the boundary 33 between the location identifier and the cell identifier is set as a standard boundary this is illustrated by step 390 and 392. For example, if the network parameters require a conventional cell identifier such as cell global identifier six in FIG. 1, the boundary can be set to define 16 bits for the location and cell identifier fields. If, on the other hand, the configuration allows for flexibility as described herein, the number of bits desired for the call identifier to allow sufficient addressing multiple cells can be set in the boundary defined accordingly as illustrated by steps 387 and 388. With the cell identifier assigned and the boundary defined, the operation can continue at FIG. 6.

FIGS. 8 and 9 describe examples where the boundary 33 is potentially defined both at the cell-identification and location-identification definition processes. However, as would be apparent to one of ordinary skill in the art, this boundary can be defined in advance and used to bound the assignments for both the cell and location identifications. The boundary can also be redefined as network evolution may change the desired allocations or as other developments may drive different boundaries for the identifications.

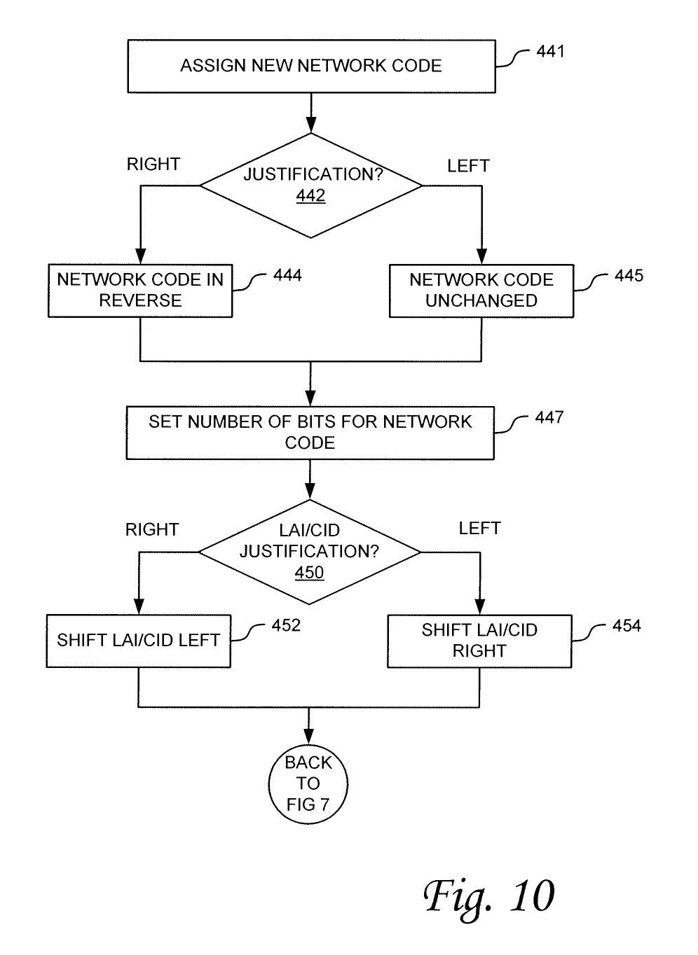

FIG. 10 is a diagram illustrating an example embodiment for assigning a network code in accordance with one embodiment of the invention. The example illustrated at FIG. 10 is a sample process for performing step 227 FIG. 7. Referring now to FIG. 10, in a step 441 the new network code is assigned. After assignment, it is determined whether the network code should have left or right justification and its justification is set accordingly. This is illustrated by steps 442, 444 and 445.

In a step 447 the number of bits can be set for the network code. This can be done after the code is assigned or it can be done in advance of assigning code such that code can be assigned with an appropriate code boundaries. Setting the number of bits for the network code can also be done when setting the boundary 33 between the network and cell identifiers. Justification of the network code can be determined based on whether the network code will be the least most significant bits for the most significant bits of the location and cell identifier. Accordingly, the network code can be shifted left or right accordingly and it can be reversed if the specification calls for such operation. This is illustrated by steps 450, 452 and 454.

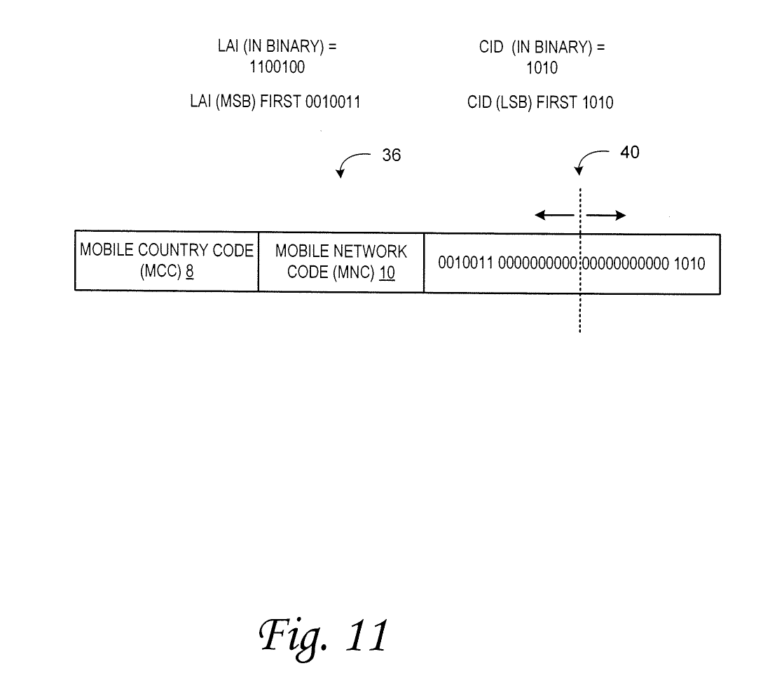

FIG. 11 is a diagram illustrating an example of a concatenated cell identifier 36. Particularly, this example is similar to that shown in FIG. 5 but illustrates a flexible partition 40 within the free field space 38. As illustrated by the opposing arrows, partition 40 can be positioned and chosen to place the desired boundaries for the location and cell identifiers. That is, for example, for a network that is encoded to have relatively few locations but large numbers of cells within each location, flexible partition 40 would typically be shifted to the left to allow a larger number of bits to be allocated to the cell identifiers, thereby allowing the larger number of cell identifiers to be assigned in each location. The converse is true in that where a large number of locations are desired to be defined, each location having a relatively smaller number of cells therein. In this case, flexible partition 40 can be shifted to the right to accommodate a large number of locations each having a smaller possible number of cells identified therein.

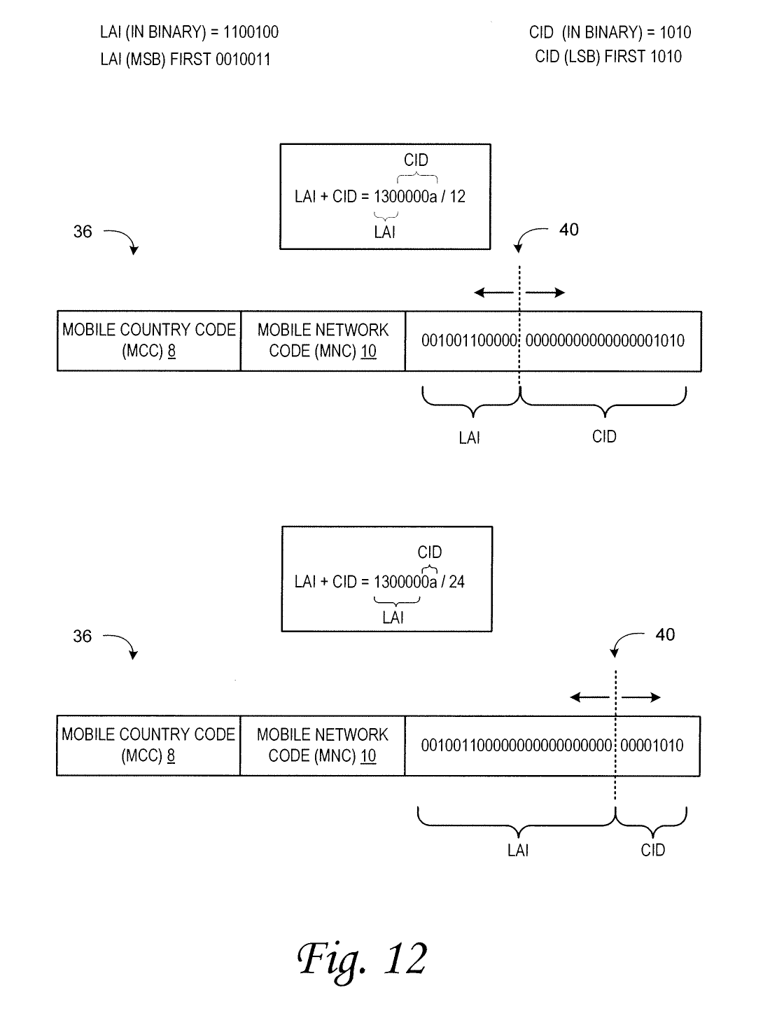

FIG. 12 is a diagram illustrating examples for setting a boundary 40 between a location identifier and a cell identifier in accordance with example implementations of the invention. In both examples, the location identifier 1100100 and the cell identifier 1010 are defined as they were above with respect to FIG. 5. However, in the top example in FIG. 12, 12 bits are delegated to the location identifier and the remaining 20 bits delegated to the cell identifier, whereas in the bottom example 24 bits are assigned to the location identifier and eight bits are reserved for the cell identifier. As seen in FIG. 12, partition 40 illustrates this for each example.

Also illustrated in FIG. 12 is an example syntax that can be used to define the location identifier and cell identifier and the partition location. In the top half of FIG. 12, the location and cell identifiers in hex format are concatenated together as 1300000A. The/12 designation indicates that 12 bits are designated for the location identifier. By default, the remaining bits in the concatenated location and cell identifier field remain for the cell identifier—which in terms of the above example is the 20 remaining bits. Similarly, in the lower half FIG. 12 the location and cell identifier 1300000A is followed by the syntax/24, indicating that 24 bits are reserved for the location identifier and the remaining bits reserved for the cell identifier. Of course, in embodiments, alternative syntax can be adopted.

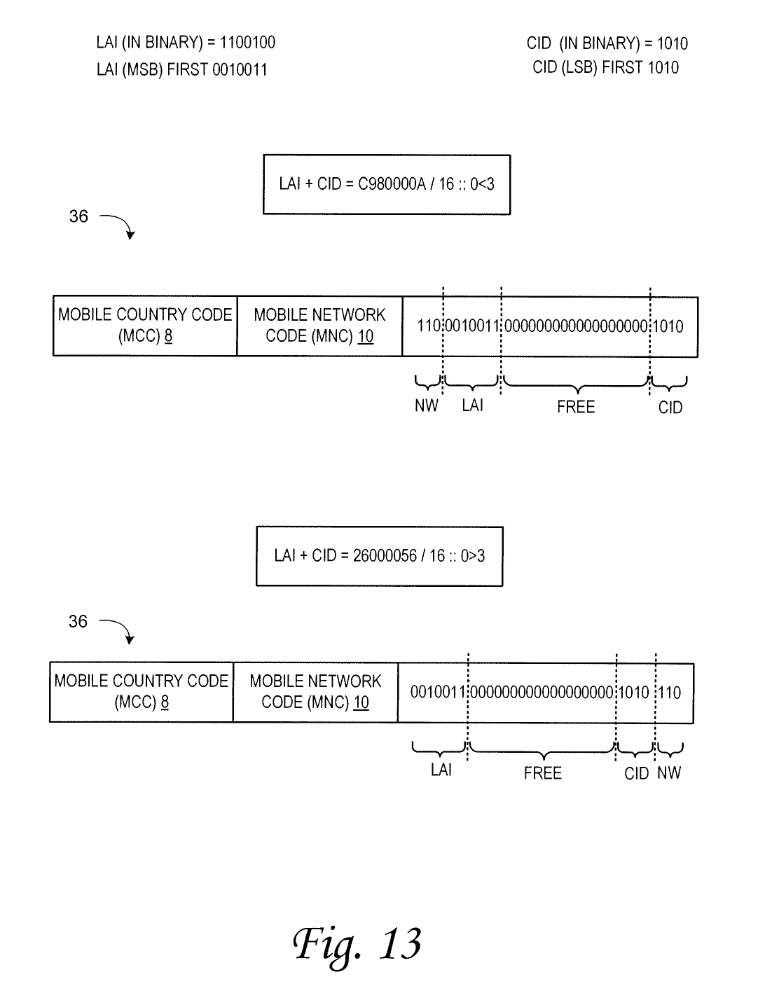

FIG. 13 is a diagram illustrating another example for the concatenated cell identifier 36 in accordance with additional implementations of the invention. Referring now to FIG. 13, this example illustrates two cases of including a network designation 110 with the concatenated location and cell identifier field. In the top example of FIG. 13, the network identifier 110 is concatenated to the most significant bits of the field. In the bottom example of FIG. 13, the network identifier 110 is concatenated onto the three least significant bits of the field. These examples illustrate the bits that make up the used portions of the location identifier, LAI, and the cell identifier, CID, in both examples, and also illustrate the free bits between the two. In accordance with embodiments described above, a partition can be identified and defined in the free portion to place boundaries on the LAI and CID.

Various forms of syntax can be used to identify the location and size of the network identifier in the field. In the top example, the syntax provided is in hex format C980000A/16::0<3. The ::0<3 indicates that the network identifier occupies the three most significant bits of the field. Although the partition is not illustrated in the example, the syntax also indicates that 16 bits are devoted to the location identifier. Likewise, in the lower half, the field is designated by the hex format 26000056 and the syntax/16::0>3 indicates that 16 bits are delegated to the location identifier and the network identifier occupies the three least significant bits of the field.

To illustrate the difference between conventional methods for a cell identifier and embodiments described herein, consider an example of an old method wherein, in decimal form, 00689 00100 would refer to base station 100 in location area 689. Under an embodiment described herein, 8d400064/20 would describe the base station 100 in location area 689 in hexadecimal format. Referring to the binary notation for this below illustrates how the addressing method operates in some embodiments. The “/20” means that the lowest 12 bits are used for the base station identifier within the top 20 bits used for the modified location identifier.

689=1010110001 in binary
100=1100100 in binary
10001101010000000000000001100100

The left-most underlined section is the binary representation of 689 in reverse, and the 100 is the right-most underlined section at the end to complete the 32 bit identifier.

Addressing methodologies such as those described above can provide flexibility for network configuration, but can be inconsistent with conventional standards that have fixed or differing partition requirements and may impact legacy equipment or norms, particularly in paging. To overcome this, the embodiment described with reference to FIG. 13 illustrates a special identifier “::X” that sets the X bits in positions bitfield/NN . . . [NN-X] as the mask for a paging area and a further operation can be performed to allow the paging within legacy equipment. A negative value would mean start from the bit field at the most significant bit. The preferred action is an XOR, but other algorithms could be used. It is noted that ::0 is the same as using the method without this additional step.

As per our example 234 15 8d400064/20::0 would use the addressing as described.

234 15 8d400064/20::4 would page in the LAI of the top 16 bits.

Various networks are not homogenous and can have different layers. For example, cellular networks can have a macro, femto, pico and other layers. To address this hierarchy, a subsection of the 32-bit address space can be used to define specific parameters such as a network type as described above with reference to FIG. 13. In one example consider an embodiment in which four bits are allocated to the network type, and designated as the top four bits of the location identifier. To maintain contiguous address space integrity positioning of the identifier can be justified orthogonal to the adjacent field (i.e. the modified location or cell identifier).

1^{st} entry 1

2^{nd} entry 10

3^{rd} entry 11

4^{th} entry 100

and so on

In this example we set the 3 least significant bits to be the type of network and the most significant bit to zero for normal operation and 1 for an experimental network. Examples are illustrated in Table 1.

TABLE 1

| Bit field | Type of network |
|---|---|
| 0000 | Reserved (example) |
| 1000 | Experimental network |
| 0001 | Standard Macro network |
| 1001 | Experimental macro network |
| 0010 | Microcell network |
| 0011 | Picocell network |
| 1100 | Experimental femtocell network |
| 0100 | Femtocell network |

In this example the “>N” and “<N” parameters are used for the segmentation. As per the example of FIG. 13, the “<4” could means that the uppermost 4 bits are used for the network description and the “>4” would mean the lowest 4 bits. The “/N” described earlier is not changed in this example. The “>0” and <0″ are special cases and means that the bits are not used. As examples, 234 15 8d400064/20::0>0 and 234 15 8d400064/20::0<0 would use the addressing as described; 234 15 8d400064/20::0<4 would describe an experimental network; and 234 15 8d400064/20::0>4 would describe a femtocell network.

Further embodiments can include wildcards or don't-care states to provide additional enhancements to the systems and methods described herein. The use of wildcard and don't-care states can allow the contiguous address space to be split or handle and addressed in bulk, in some implementations, providing greater flexibility. Accordingly, through the use of a wildcard or don't care, for example, a group of access points can be identified by a single address. This can be implemented, for example, in a neighbor list to allow a group of neighbor access points to be identified for handoff purposes by a single address. This can lead to advantages of reduced address space and reduced churn. For example, as would be apparent to one of ordinary skill in the art after reading this description, thresholds or other parameters or probabilistic events can be used in conjunction with the invention to determine whether a hard or soft handoff is warranted or advised, and if so, the process can use the neighbor list to determine a candidate base station or base stations to which the handoff can be made. Such parameters, thresholds or other event information can be part of, associated with or independent of a neighbor list depending upon specific implementations.

The use of wildcards can be considered in assigning identifiers to access points. In some embodiments, cell identifiers are assigned to access points in logical groupings based on likely handoff scenarios to improve the use of special characters like wild cards and don't care characters. Consider an example of a building build-out for a building that has eight floors or suites, and each floor or suite has eight femtocells strategically positioned therein to obtain coverage. Consider further an operational scenario wherein users in the building generally stay within their assigned floor or suite, buy may wander or roam throughout that floor. Accordingly, efficiencies can be gained if each of the eight femtocells on each floor are uniquely identified by the three least significant bits of the cell identifier. Also, each of the eight floors are uniquely identified by the next three bits, each of the 64 separate access points has a unique address. With this assignment, their neighbor list can use don't-cares for the three least significant bits in a single address, with the next three bits identifying the floor they are on. In this case, the single entry identifies every femtocell on that user's floor as a possible neighbor for handoff purposes. In cases where mobility is potentially extended to adjacent floors, additional entries can be entered for each floor, again using don't cares for the access points within each floor. Thus, eight entries identify 64 possible neighbors. With conventional phone architectures, this leaves 24 entries for additional neighbors such as macrocells surrounding the building. This is a specific example, but illustrates the power that can be achieved through wild cards and don't cares. As would be apparent to one of ordinary skill in the art after reading this, the use of wild cards and don't cares is scalable.

In the example described below in Table 2, example operators “?” and “x” are used for a wildcard and don't care parameters respectively. Table 2 sets forth this example.

TABLE 2

| Bit field | Hex notation | Notes |
|---|---|---|
| xxxx | x | |
| 1??? | 8? = | 8 thru 15 |
| 1?? | 4? = | 4, 5, 6, 7 |
| 1? | 2? = | 2, 3 |

Some examples are:

234 15 8d400064/20::0>4 represents the a particular femtocell network

234 15 xxxxxxx4/20::0>4 represents all femtocell networks

234 15 8d4?00064/20::0 represents

234 15 8d400064/20,

234 15 8d500064/20

234 15 8d600064/20,

234 15 8d700064/20

Of course, the apparatus and methods described herein can be implemented in a way that is agnostic to the manner in which the notation is utilized. Decimal, hexadecimal, binary or other notation can be used as cannon upper or lower case, punctuation separators, or other human assisted methods. This is as would be apparent to one of ordinary skill in the art. For example, 234 15 8d400064/20 is equivalent to 235.15.8d.40.00.64/20 or 235,15,141,64,0,100/20 or 234 15 2 369 781 860 etc. If it aides clarity then the MCC MNC although not modified can be considered within the context of the description.

To further describe example embodiments, consider a simple example with 1000 femtocells split into blocks of 16, where the same network parameters were reused plus four macro cells. Using the conventional approach as described in FIG. 1, this would be a problematic scenario as the macrocell does not have 1000 entries available, nor does the femtocell have the capacity to describe the surrounding network properly. The macrocell would have 10 entries, the femtocell one or two. Examples of macrocell topology entries are
Host cell 234 15 8d400051/20::0>4
End 234 15 8d400011/20::0>4
Femtocell
Start 234 15 8d400064/20::0>4
End 234 15 8d403ec4/20::0>4
Macro Neighbour List
Host cell 234 15 8d400051/20::0>4
Host->Destination cell 234 15 8d400041/20::0>4 MACRO_PARAMS
Host->Destination cell 234 15 8d400031/20::0>4 MACRO_PARAMS
Host->Destination cell 234 15 8d400021/20::0>4 MACRO_PARAMS
Host->Destination cell 234 15 8d400011/20::0>4 MACRO_PARAMS
Host->Destination cell 234 15 8d403?ec4/20::0>4 FEMTO_PARAMS Etc
Femtocell Neighbour List (macro-only)
Host cell 234 15 8d400064/20::0>4
Host->Destination cell 234 15 8d40005?1/20::0>4 MACRO_PARAMS

The addressing scheme allows the addresses to be overloaded and the shorthand used. Various embodiments of the invention can be implemented so as to overcome problems conventionally associated with processing a large number of nearest neighbors. According to various embodiments, a large neighbor list can be constructed using a minimal number of entries. This can have the advantage, in some implementations, of reducing complexity, processing time and operational costs. The techniques described herein can be utilized in various applications to create a numerical topology rather than a geographic led topology. This can provide efficient address space utilization and can scale to very large addresses in some addresses.

With super netted networks using common prefixes and address space, national roaming with the femtocell's can be accomplished in various embodiments. Recognizing the ability to maintain consistency with conventional cell identifiers, backwards compatibility can be maintained with existing practices. Likewise, standards compatibility can be achieved.

Further embodiments of the invention can allow for features such as an efficient description of the address space, flexibility in describing and creating the address space, maintaining compatibility with existing implementations, reducing overgrown neighbor lists, shorthand notation using wildcards and the like, and allowing multiple base station addressing for mobility events. Additionally, multiple subnetworks can be concatenated to create a super net.

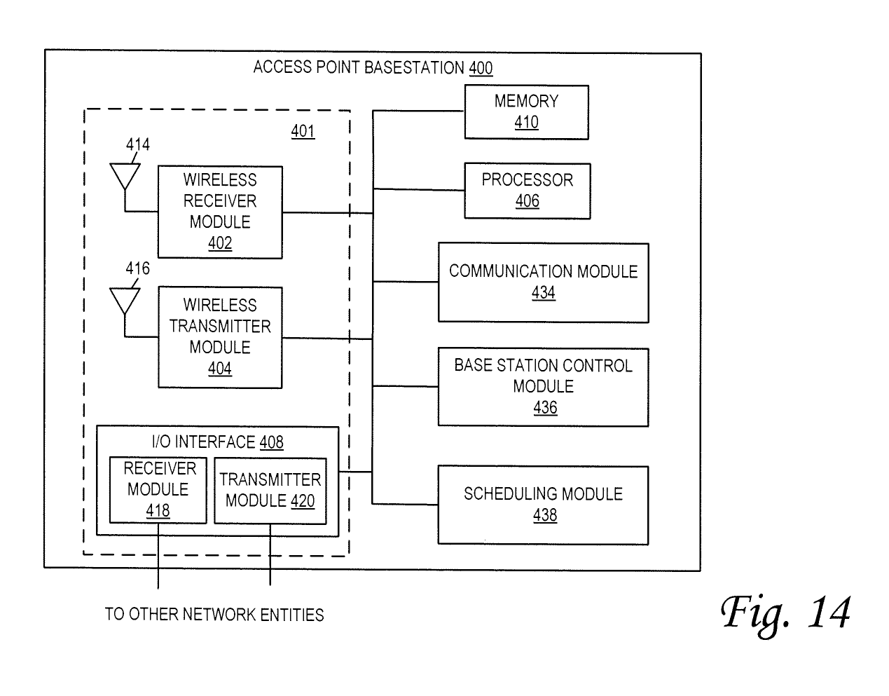

FIG. 14 is a diagram illustrating a block diagram for an example wireless access point or base station in accordance with one embodiment of the invention. In particular, the example architecture illustrated in FIG. 14 shows an embodiment of an access point architecture configured to transmit and receive messages to and from an access point controller over a communication link such as a backhaul, and configured to transmit and receive messages to and from UEs or other wireless terminals.

In this example architecture, the access point 400 includes a communication module 401, a processor 406, and memory 410. These components are communicatively coupled via a bus 412 over which these modules may exchange and share information and other data. Communication module 401 includes wireless receiver module 402, a wireless transmitter module 404, and an I/O interface module 408.

An antenna 416 is coupled to wireless transmitter module 404 and is used by access point 400 to wirelessly transmit downlink radio signals to wireless terminals with which it is connected. These downlink RF signals can include voice and data communications sent to the wireless terminals registered with the access point 400 to allow routine communication operations of the cell. The downlink RF signals can also include control signals such as, for example, uplink power control signals that are sent to registered wireless terminals to allow access point 400 to control the uplink transmit power of the wireless terminals that are communicating with access point 400 as a point of attachment to the cell.

Antenna 414 is included and coupled to wireless receiver module 402 to allow access point 400 to receive signals from various wireless terminals within its reception range. Received signals can include voice and data communications from a wireless terminal in the access point's cell coverage area for routine communication operations. Accordingly, signals such as wireless uplink signals from registered wireless terminals that have a current connection with access point 400 are received. Also, access point 400 typically receives various housekeeping or control signals from wireless terminals such as an uplink pilot signal, for example.

Although two antennas are illustrated in this and other example architectural drawings contained herein, one of ordinary skill in the art will understand that various antenna and antenna configurations can be provided as can different quantities of antennas. For example, transmit and receive functions can be accommodated using a common antenna or antenna structure, or separate antennas or antenna structures can be provided for transmit and receive functions as illustrated. In addition, antenna arrays or other groups of multiple antennas or antenna elements, including combinations of passive and active elements, can be used for the transmit and receive functions.

An I/O interface module 408 is provided in the illustrated example, and can be configured to couple access point 400 to other network nodes. These can include nodes or equipment such as, for example, other access points, and an access controller. In this example architecture, the I/O interface module 408 includes a receiver module 418 and a transmitter module 420. Communications via the I/O interface module can be wired or wireless communications, and the transmitter and receiver contained therein can include line drivers and receivers, radios, antennas or other items, as may be appropriate for the given communication interfaces. Transmitter module 420 is configured to transmit signals that can include voice, data and other communications to the access controller. These are typically sent in a standard network protocol specified for the cellular backhaul.

Receiver module 418 is configured to receive signals from other equipment such as, for example, other access points (in some embodiments, via the access controller), and an access controller. These signals can include voice, data and other communications from the access controller or other equipment. These are typically received in a standard network protocol specified for the cellular backhaul.

Memory 410, can be made up of one or more modules of one or more different types of memory, and in the illustrated example is configured to store data and other information 424 as well as operational instructions such as access point control routines 422. The processor 406, which can be implemented as one or more CPUs or DSPs, for example, is configured to execute instructions or routines and to use the data and information 424 in memory 410 in conjunction with the instructions to control the operation of the access point 400. For example, access point control routines can include instructions to enable processor 406 to perform operations for transferring data between wireless terminals and the access point controller, and for managing communications with and control of wireless terminals.

Accordingly, a communication module 434 can be provided at a femtocell access point to manage and control communications received from other network entities such as a femtocell controller or other access point basestations, and to direct appropriate received communications to their respective destination wireless terminals. Likewise, communication module 434 can be configured to manage received communications from wireless terminals and direct them to their next destination such as, for example to the femtocell controller for transfer to the core network. Communication module 434 can be configured to manage communication of control information sent to and received from wireless terminals. As such, communication module 434 can manage wireless communications such as uplink and downlink communications with wireless terminals as well as wired communications such as those conducted over the Ethernet (or other) backhaul.

A base station control module 436 can be included to control the operation of access point base station 400. For example, the station control module 436 can be configured to implement the features and functionality described above for communicating and transferring information among wireless terminals, other femtocells, and a femtocell controller. A scheduling module 438 can also be included to control transmission scheduling or communication resource allocation. Information that is used by base station control module 436 and scheduling module 430 can also be included in memory 410 such as entries for each active mobile node or wireless terminal, which lists the active sessions conducted by a user and can also include information identifying the wireless terminal used by a user to conduct the sessions.

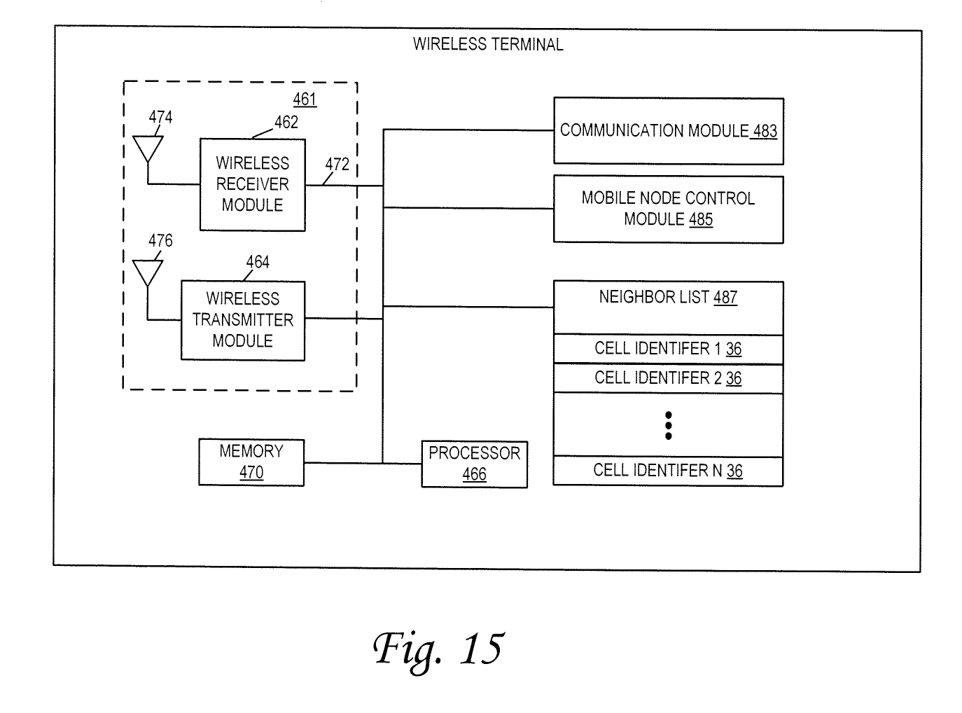

FIG. 15 is a diagram illustrating an example architecture for a wireless terminal in accordance with one embodiment of the invention. Referring now to FIG. 15, wireless terminal also includes a communication module 461 similar to communication module 701 contained within the example access point. The communication module eight of one enables the wireless terminal to communicate voice and data information as well as control information with its serving access point. Accordingly, user information such as voice and data traffic can be communicated between the wireless terminal and the access point and ultimately between the wireless terminal and other devices (such as, for example, the core network) for routine device operations. Likewise, the communication module can be configured to receive control information from the access point to control the wireless terminal to perform desired operations can transmit data, infrastructure, or other control information such as pilot signals, scrambling codes, and so on.

Processor 466 and memory 470 are also typically included in the can be utilized to perform device functions of the wireless terminal. Various modules can be included to perform device operations, both routine wireless terminal device operations as well as specific operations described above for network monitoring and reconfiguration. These can include a communications module 483 and a mobile node control module 485. For example, mobile node control module 485 can be configured to control handoff processes in conjunction with the neighbor list 487.

The neighbor list can include one or more cell identifiers that can include a cell identification field configured to store a first data representation identifying a cell in the cellular network and a location identification field adjacent the cell identification field and configured to store a second data representation identifying a location in the cellular network. As described above, one of the first and second data representations can be constructed from a least significant bit of its respective field and the other of the first and second data representations is constructed from the most significant bit of its respective field.

In some implementations, the cell identification field and the location identifier field are a contiguous concatenated field and further comprising a partition in the concatenated field between the cell identification field and the location identifier field defining a bound to the number of bits in each field. The special character can include a wild card or a don't care character.

The cell identifier stored in the memory device at the wireless terminal can be used as an access point neighbor list, which can identify access point topological adjacencies in the communication network, or can identify access points to which a handoff may be implemented. The list can include one or more cell identifiers stored in the memory device, and a subset of some or all of the cell identifiers in the access point neighbor list can include one or more special characters. In one embodiment, the cell identifiers are assigned to access points in logical groupings based on handoff probabilities.

Although not illustrated, user, device and session resource information can be stored in memory 470 to facilitate operations. Also illustrated is a neighbor list 487 that can be stored in memory 470 or otherwise stored or maintained on the wireless terminal. Neighbor list 487 includes one or more cell identifiers, such as cell identifiers 36, that can be used for operations such as handoff operations. The cell identifiers can include the features set forth herein to facilitate addressing. For example, wild cards or don't cares can be used to allow a single identifier to address a group of access points to which the handset might be handed off.

As used herein, the term set may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

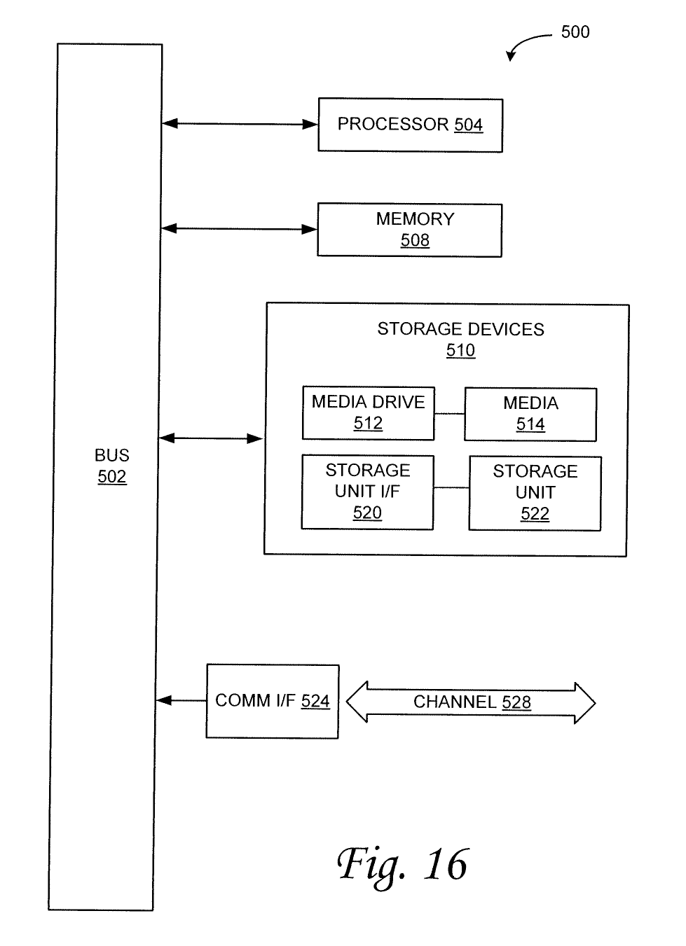

As used herein, the term module can describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 16. Various embodiments are described in terms of this example—computing module 500. After reading this description, it will become apparent to a person skilled in the relevant art how to implement the invention using other computing modules or architectures.

Referring now to FIG. 16, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the ten is “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. In a cellular communication network having a plurality of access points serving wireless terminals, a method for facilitating handoff of a wireless terminal from a first access point to a second access point, the method comprising:
storing in a memory device at the wireless terminal a cell identifier, wherein the cell identifier includes a special character enabling the cell identifier to identify a plurality of access points to which the wireless terminal can be handed off; and
the wireless terminal using the stored cell identifier to determine access points to which a handoff may be implemented.

2. The method of claim 1, wherein the cell identifier comprises:
a cell identification field configured to store a first data representation identifying a cell in the cellular network;
a location identification field adjacent the cell identification field and configured to store a second data representation identifying a location in the cellular network; and
wherein one of the first and second data representations is constructed from a least significant bit of its respective field and the other of the first and second data representations is constructed from the most significant bit of its respective field.

3. The cell identifier of claim 1, wherein the cell identification field and the location identifier field are a contiguous concatenated field and further comprising a partition in the concatenated field between the cell identification field and the location identifier field defining a bound to the number of bits in each field.

4. The method of claim 1, wherein the special character comprises a wild card or a don't care character.

5. The method of claim 1, wherein the cell identifier stored in the memory device at the wireless terminal is an access point neighbor list.

6. The method of claim 5, wherein the access point neighbor list further comprises additional cell identifiers stored in the memory device.

7. The method of claim 5, wherein the access point neighbor list identifies access point topological adjacencies in the communication network.

8. The method of claim 5, wherein some or all of the cell identifiers in the access point neighbor list comprise a special character.

9. The method of claim 1, further comprising storing additional cell identifiers in the memory device at the wireless terminal to form a neighbor list at the wireless terminal to identify access points to which a handoff may be implemented.

10. The method of claim 1, wherein cell identifiers are assigned to access points in logical groupings based on handoff probabilities.

11. A wireless terminal for use in a cellular communication network having a plurality of access points serving wireless terminals, the wireless terminal comprising:
a wireless transceiver configured to send communications to and receive communications from an access point;
a memory storing a cell identifier that includes a special character enabling the cell identifier to identify a plurality of access points to which the wireless terminal can be handed off; and
a control module configured to use the stored cell identifier to determine access points to which a handoff may be implemented.

12. The wireless terminal of claim 11, wherein the cell identifier comprises:
a cell identification field configured to store a first data representation identifying a cell in the cellular network;
a location identification field adjacent the cell identification field and configured to store a second data representation identifying a location in the cellular network; and
wherein one of the first and second data representations is constructed from a least significant bit of its respective field and the other of the first and second data representations is constructed from the most significant bit of its respective field.

13. The wireless terminal of claim 11, wherein the cell identification field and the location identifier field are a contiguous concatenated field and further comprising a partition in the concatenated field between the cell identification field and the location identifier field defining a bound to the number of bits in each field.

14. The wireless terminal of claim 11, wherein the special character comprises a wild card or a don't care character.

15. The wireless terminal of claim 11, wherein cell identifiers are assigned to access points in logical groupings based on handoff probabilities.

16. The wireless terminal of claim 11, wherein the cell identifier stored in the memory is an access point neighbor list.

17. The wireless terminal of claim 16, wherein the access point neighbor list further comprises additional cell identifiers stored in the memory.

18. The wireless terminal of claim 16, wherein the access point neighbor list identifies access point topological adjacencies in the communication network.

19. The wireless terminal of claim 16, wherein some or all of the cell identifiers in the access point neighbor list comprise a special character.

20. The wireless terminal of claim 11, further comprising storing additional cell identifiers in the memory device at the wireless terminal to form a neighbor list at the wireless terminal to identify access points to which a handoff may be implemented.

21. An access point for use in a cellular communication network having a plurality of access points serving wireless terminals, the access point comprising:
a wireless transceiver configured to send communications to and receive communications from a wireless terminal, wherein communications sent to the wireless terminal include a cell identifier that includes a special character enabling the cell identifier to identify a plurality of access points to which the wireless terminal can be handed off such that the wireless transceiver can use the stored address information to determine access points to which a handoff may be performed.

22. The access point of claim 21, wherein the cell identifier comprises:
a cell identification field configured to store a first data representation identifying a cell in the cellular network;
a location identification field adjacent the cell identification field and configured to store a second data representation identifying a location in the cellular network; and
wherein one of the first and second data representations is constructed from a least significant bit of its respective field and the other of the first and second data representations is constructed from the most significant bit of its respective field.

23. The access point of claim 21, wherein the cell identification field and the location identifier field are a contiguous concatenated field and further comprising a partition in the concatenated field between the cell identification field and the location identifier field defining a bound to the number of bits in each field.

24. The access point of claim 21, wherein the special character comprises a wild card or a don't care character.

25. The access point of claim 21, wherein cell identifiers are assigned to access points in logical groupings based on handoff probabilities.

26. The access point of claim 21, wherein the cell identifier stored in the memory is an access point neighbor list.

27. The access point of claim 26, wherein the access point neighbor list further comprises additional cell identifiers stored in the memory.

28. The access point of claim 26, wherein the access point neighbor list identifies access point topological adjacencies in the communication network.

29. The access point of claim 26, wherein some or all of the cell identifiers in the access point neighbor list comprise a special character.
